(19) United States
(12) Patent Application Publication
(10) Pub. No.: US 2021/0144313 A1
(43) Pub. Date: May 13, 2021

(54) LOGO CAMERA

(71) Applicant: Microsoft Technology Licensing, LLC, Redmond, WA (US)

(72) Inventors: Timothy A. Large, Bellevue, WA (US); Neil Emerton, Redmond, WA (US); Yonghuan David Ren, Berkeley, CA (US)

(21) Appl. No.: 16/679,183

(22) Filed: Nov. 9, 2019

(51) Int. Cl. H04N 5/232; H04N 9/04; H04N 5/225

(52) U.S. Cl. CPC H04N 5/232939; H04N 5/2253; H04N 5/2256; H04N 9/0455

(57) ABSTRACT

Methods, systems and computer program products are provided for a logo camera. Camera thickness may be reduced using multiple lenses and sensors. A fixed or variable color icon may provide a function, notice or privacy warning, convey information, and/or serve decorative and/or other purposes. Color filters may be fixed or variable. A color icon may be created, for example, by controlling the colors of display pixels aligned with optical paths of camera lens and sensor arrays. Colors in an icon may provide color filters corresponding to an array of lenses that focus color-separated light on one or more camera sensors. Sensors may be optimized for particular colors. Color-separated images may be combined into a single image. Lens and camera sensor arrays may be compatible with multiple logos or other icon images. Cameras behind fixed or variable color icons may be concealed, for example, using shutters or semi-reflective layers.

### BACKGROUND

Cameras integrated into devices (e.g. cell phones, tablets, desktop displays) are usually placed in bezels. Bezels are shrinking, screens are becoming larger and bezels and screens are becoming thinner. Camera thickness may be related to optical properties (e.g. lens elements, focal length, focal ratio).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided for a logo camera. Camera thickness may be reduced using multiple lenses and sensors (e.g. to reduce focal length). A fixed or variable color icon (e.g. for front and/or rear-facing cameras) may (e.g. simultaneously) provide a function (e.g. fixed or variable camera filter), provide a notice or privacy warning (e.g. camera in-use notification), convey information (e.g. product manufacturer and/or ownership logo(s), personal or unique avatar), and/or serve decorative and/or other purposes. Color filters may be fixed or variable. A color icon may be created, for example, by controlling the colors of display pixels aligned with optical paths of camera lens and sensor arrays. Colors in an icon may provide color filters (e.g. according to any of various color models) corresponding to an array of lenses that focus color-separated light on one or more camera sensors. Sensors may be configured for particular colors. Color-separated images may be combined into a single image. Lens and camera sensor arrays may be compatible with multiple (e.g. selectable) logos or other icon images. Cameras behind fixed or variable color icons may be concealed (e.g. when not in use), for example, using (e.g. liquid crystal) shutters or semi-reflective layers.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 is a block diagram of an example logo camera system, according to an example embodiment.

FIGS. 2A-2B provide examples of front-facing and rear-facing logo cameras in a portable computing device, according to an example embodiment.

FIG. 3 is a block diagram of an example logo camera in a display screen of a computing device, according to an example embodiment.

FIG. 4 is a block diagram of an example lens array for a logo camera, according to an example embodiment.

FIG. 5 is a block diagram of an example of a camera color filter providing a camera-use indication, an icon and color filtering for a logo camera, according to an example embodiment.

FIG. 6 is a block diagram of an example of display pixels providing a camera-use indication, an icon and color filtering for a logo camera, according to an example embodiment.

FIGS. 7A-C show additional examples of icons or logos, color filter configurations, and color model configurations, according to example embodiments.

FIG. 8 shows a flowchart of a method for providing a logo camera, according to an example embodiment.

FIG. 9 shows a block diagram of an example computing device that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

Cameras integrated into devices (e.g. cell phones, tablets, desktop displays) are usually placed in bezels. Bezels are shrinking, screens are becoming larger and bezels and screens are becoming thinner. Camera thickness may be related to optical properties (e.g. lens elements, focal length, focal ratio). Decreasing camera thickness may decrease camera quality and reduce features. A camera may be integrated with a display, but it may increase device thickness. A camera may be integrated with a display to avoid increasing thickness, for example, by cutting out a portion of a display to provide an optical path for a camera. A cutout may permanently eliminate the portion of the display cut out, interfering with display continuity. Moreover, a through-display camera may incur signal loss caused by absorption and image quality loss by diffraction and scattering from display components. Display color would have to be set to white to pass all colors if a camera color filter remained on an image sensor.

Display color filter performance may be similar to camera color filter performance. A color filter in an image sensor may be eliminated. An external color filter (e.g. a display color filter or a passive color filter) may provide color filtering, e.g., among other functions. An active camera color filter may permit filter density to be selected, for example, to improve (e.g. enhance or optimize) color and low light performance. Image sensor color filter pixels may be distributed between multiple (e.g. four) color-separated color filters to provide color-separated light to multiple (e.g. four) lens arrays and multiple (e.g. four) image sensors or image sensor regions. A lens track may be reduced (e.g. by half), for example, without changing a signal level received by the multi-element or multi-camera assembly. Pixel density may be increased, for example, to retain camera resolution. A passive or active color filter may provide notice that a camera is on and/or may consist of an icon, such as a company logo or personal avatar. In a rear-facing implementation (e.g. where it may not be necessary to decrease the thickness of a camera assembly), camera sensitivity may be enhanced (e.g. with a multi-camera assembly), for example, by maintaining camera dimension and increasing image sensor area.

Methods, systems and computer program products are provided for a logo camera. Camera thickness may be reduced using multiple lenses and sensors (e.g. to reduce focal length). A fixed or variable color icon (e.g. for front and/or rear-facing cameras) may (e.g. simultaneously) provide a function (e.g. fixed or variable camera filter), provide a notice or privacy warning (e.g. camera in-use notification), convey information (e.g. product manufacturer and/or ownership logo(s), personal or unique avatar), and/or serve decorative and/or other purposes. Color filters may be fixed or variable. A color icon may be created, for example, by controlling the colors of display pixels aligned with optical paths of camera lens and sensor arrays. Colors in an icon may provide color filters (e.g. according to any of various color models) corresponding to an array of lenses that focus color-separated light on one or more camera sensors. Sensors may be configured (e.g. selected, performance-enhanced or optimized) for particular colors. Similar to filters, sensors may be configured (e.g. based on materials, layers, coatings and so on) to pass (and to reject or attenuate) particular wavelengths of light. Wavelength range-specific sensors may (e.g., accordingly) be more responsive to selected ranges of wavelengths than unselected ranges of wavelengths. Color-specific sensors may increase quantum efficiencies of sensors, thereby increasing the SNR of acquired images. Color-separated images may be combined into a single image. Lens and camera sensor arrays may be compatible with multiple (e.g. selectable) logos or other icon images. Cameras behind fixed or variable color icons may be concealed (e.g. when not in use), for example, using (e.g. liquid crystal) shutters or semi-reflective layers.

An icon may comprise any visible multi-colored object or image regardless how it is made visible. In an example, an icon may be made visible, for example, by an active device, such as a computing device display. In another example, an icon may be made visible passively, such as by a dyed or fixed material. An icon may be partially or wholly fixed (e.g. unchangeable) or variable. An icon may serve one or more functions or purposes (e.g. logo camera color filters, notification of logo camera state, convey information such as device manufacturer, ownership or user). An icon may represent anything (e.g. a logo, an avatar, a scene, a flag), including nothing.

FIG. 1 is a block diagram of an example logo camera system, according to an example embodiment. Example system 100 may comprise computing device 102, with processor 106, memory 108, and display (with logo camera) 104. Example system 100 may represent a front-facing or a rear-facing implementation of a logo camera system. FIG. 1 presents one of many example implementations. Example system 100 may omit a variety of components (e.g. autofocus mechanism) and/or layers for simplification and clarity. Various implementations may have more or fewer layers than shown in FIG. 1.

Computing device 102 may comprise any computing device. Computing device 102 may be, for example, any type of stationary or mobile computing device, such as a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing device 102 may comprise one or more applications, operating systems, virtual machines, storage devices, etc. that may be executed, hosted, and/or stored therein or via one or more other (e.g. networked) computing devices. An example computing device with example features is presented in FIG. 9.

Computing device 102 may comprise display (with logo camera) 104, processor 106, and memory 108. Examples of processor 106 and memory 108 are described with respect to FIG. 9. A logo camera may be implemented by a controller, which may be implemented in hardware, firmware and/or software. In an example, one or more processors may execute code to control one or more logo cameras.

Logo camera controller 110 may be stored in storage (not shown), loaded into memory (e.g. RAM) 110 and executed by processor 106. Logo camera application 110 may comprise one or more executable programs, dynamic link libraries (DLLs), etc. Example logo camera controller 110 presents three example portions of code by program logic or tasks (e.g. icon menu 112, icon display 114 and image processor 116). Other implementations may implement code with a wide variety of logical or functional code modules. In an example, logo camera controller 110 may be implemented (in part or in whole) in an operating system (not shown) and/or in an application. Portions of logo camera controller 110 may be implemented (e.g. in an operating system) with one or more security features (e.g. to prevent hacking, to ensure notification is provided and not disabled during camera use, to provide access based on facial recognition and so on).

Icon menu 112 may present a user (e.g. of computing device 102) with a graphical user interface (GUI) displayed by display 104. Icon menu 112 may (e.g. for a variable icon such as an active color filter provided by an LCD) permit a user to select among multiple icons (e.g. company logos, avatars and other images). Icons may be based on or may be modified or adapted for lens and/or sensor arrays associated with display 104. Icon menu 112 may permit a user to select a color model for an icon, which may result in a processing adaptation by image processor 116. For example, a user may select between multiple three and four color models when there may be four optical paths to sensor(s) 128. Logo camera 110 may, for example, have a default icon and/or color model that may be used (e.g. as factory settings) when a user does not specify an icon or an icon color scheme. In an example, an icon may be fixed (e.g. a rear-facing camera), in which case a user may be unable to modify an icon or its color scheme.

Icon display 114 may be responsible for creating and activating an icon for camera use notification, camera color filtering and/or to display an image. Icon display 114 may be configurable, for example, based on user input (e.g. icon selection and/or color scheme selection). Icon display 114 may adapt a selected icon and selected color model to a configuration of lens array 126 and sensor(s) 128. In other words, multiple icons may be adapted to provide camera color filters. Not all active pixels associated with an icon may provide a color filter function. Icon display 114 may activate an icon, for example, when it receives an indication (e.g. that a front- and/or rear-facing camera is turned on and/or in use). Icon/color filter activation may comprise, for example, causing a display to display the icon/color filter in an optical path of the camera and/or to illuminate a (e.g. fixed) color filter. Icon display 114 may enable camera operation by (e.g. alternatively or additionally) opening a shutter related to activation of an icon/color filter. Opening a shutter (e.g. when installed) may create an optical path to a lens and sensor array. Icon display 114 may deactivate an icon and may activate a shutter (e.g. when installed), for example, in response to deactivation of a (front- or rear-facing) logo camera.

Image processor 116 may process color-separated images received by one or more sensors. Image processor 116 may combine color-separated images into a combined (e.g. single) image. Processing may depend on multiple implementation and/or configuration parameters, such as the type of display (e.g. RGB subpixels), logo camera color model (e.g. RGB, RGBY, RGBW, RGBE, RYYB, CMYW, CYYM, CYGM, and so on), processed image color representation (e.g. RGB), which may necessitate conversions, optical path properties (e.g. percentage of light reaching sensors, noise), etc.

Display 104 may comprise one or more logo cameras. Logo cameras may face any direction (e.g. front-facing, rear-facing, side-facing). Display 104 may comprise any type and size of display. In an example, display 104 may comprise a liquid crystal display (LCD), a light emitting diode (LED) display, an organic LED (OLED) display, active matrix OLED (AMOLED) display, quantum dot (QD) LED display, plasma display panel (PLP), electroluminescent display (ELD), etc. Some technologies may operate with front-facing and rear-facing logo cameras while other technologies may work with rear-facing logo cameras. Some technologies may be modified to support front-facing (e.g. through-display) logo cameras. In an example, additional filters may be added behind an OLED, e.g., when there are optical paths between pixels, for example, to implement a front-facing logo camera.

Logo cameras may be integrated with (e.g. implemented behind) display 104. The level of integration may vary depending on the application. For example, in a front-facing application where a logo camera has an optical path through display 104, small (e.g. 1 mm) holes may be implemented in one or more layers (e.g. a reflective layer) of display 104 to provide optical paths through display 104 to lens array 126 and sensor(s) 128. In a rear-facing application, a logo camera may be implemented without editing layers or components of a display in display 104.

Display 104 may comprise multiple layers, such as, for example, color filter/icon 118, light guide 120, reflector 122, shutter 124, lens array 126 and image sensor(s) 128. Display 104 may omit a variety of display components and/or layers for simplification and clarity to show components and layers that may be implemented in multiple (e.g. front-facing and rear-facing) logo cameras with passive and/or active color filters. Various implementations may have more or fewer layers than shown in FIG. 1.

Optical layers shown in display 104 may represent layers in multiple implementations (e.g. front-facing and rear-facing implementations) of a logo camera. In an example of a front-facing logo camera, shutter 124, lens array 126 and sensor(s) 128 may be positioned behind and may utilize display layers in display 104 (e.g. from reflector 122 forward). In an example of a rear-facing logo camera, color filter/icon 118, light guide 120, reflector 122, shutter 124, lens array 126 and image sensor(s) 128 may be positioned behind (e.g. facing opposite direction) and may not utilize any display layers in display 104.

A front-facing logo camera may receive light via an optical path through a portion of display 104. Display 104 may comprise, for example, a liquid crystal display (LCD) with (e.g. RGB) subpixels provided by a subpixel color filter array. A rear-facing logo camera may be located behind display 104 with an optical path through an opening in a case (not shown) behind display 104. A case (not shown) may comprise any supportive material, e.g., rigid plastic, metal, with an optical path for a rear-facing logo camera.

Icon 118 may be visible to a user. Icon 118 may serve multiple purposes. Icon 118 may (e.g. simultaneously) provide a function (e.g. fixed or variable camera filter), provide a notice or privacy warning (e.g. camera in-use notification), convey information (e.g. product manufacturer and/or ownership logo(s), personal or unique avatar), and/or serve decorative and/or other purposes.

Icon 118 may be referred to as a color filter. Icon/color filter 118 may comprise multiple wavelength-sensitive color filters that filter light wavelengths into color-separated light. Icon/color filter 118 may supplant a (e.g. Bayer pattern) camera color filter on sensor(s) 128.

Icon/color filter 118 may implement any color filter model. Colors in passive and active implementations of icon/color filter 118 may be selected using any color model (e.g. RGB, RGBY, RGBW, RGGB, RGBE, RYYB, CMYW, CYYM, CYGM, and so on). Some color models may have lower signal to noise (SNR) ratios than other color models. Colors in icon/color filter 118 may provide color filters corresponding to an array of lenses that focus color-separated light on one or more camera sensors (e.g. sensor(s) 128).

Icon 118 may comprise multiple passive and/or active, fixed or variable color filters (e.g. creating a color filter array). For example, icon 118 may comprise a fixed or variable active color filter (e.g. using display pixels) in a front-facing implementation. Icon 118 may comprise a passive and/or active (e.g. fixed or variable) color filter in a rear-facing implementation. A rear-facing logo camera with an active filter may utilize a rear-facing display (e.g. behind and facing an opposing direction of a main front-facing display that may have a front-facing logo camera). In an example of an active color filter, active icon/color filter 118 may be created, for example, by controlling the colors of active display pixels aligned with optical paths of camera lens array 126 and sensor(s) 128.

Although the example of icon/color filter 118 shown in FIG. 1 is continuous, color filters in a color filter array may be continuous or discontinuous (e.g. separated or discrete). Icon 118 may comprise different materials and may be created or activated and deactivated differently, for example, depending on whether a logo/color filter implementation is active or passive. Passive and active icon/color filters may comprise known display and color filter materials.

In an example of an active icon/color filter, icon/color filter 118 may comprise a portion of a display with an array of pixels. Each pixel may comprise, for example, RGB subpixels. Other color model subpixels may be implemented. RGB subpixels may be arranged, for example, in a chevron pixel layout with a pixel mask separating subpixels and pixels. Other subpixel layouts may be implemented.

In an example, a multi-element logo camera (e.g. multi-camera or camera array) may comprise a quad camera in a 2×2 array. Icon/color filter 118 may comprise a 2×2 array of active display pixels aligned with a 2×2 array of lenses and sensor(s) or sensor regions. Icon/color filter 118 may comprise first color filter 130, second color filter 132, third color filter 134 and fourth color filter 136. First through fourth active color filters 130, 132, 134, 136 may comprise components in a multi-element camera (e.g. camera array). First through fourth color filters 130, 132, 134, 136 may be displayed at positions on a display in alignment with cameras or camera elements (e.g. first through fourth reflector holes 148, 150, 152, 154, first through fourth lenses 166, 168, 170, 172 and first through fourth sensors or sensor regions 174, 176, 178, 180) in order for first through fourth sensors or sensor regions 174, 176, 178, 180 to receive color-separated light through first through fourth color filters 130, 132, 134, 136.

As shown in FIG. 1, first color filter 130 may display light in a first color 140 and filter received light 138 in accordance with displayed first color 140. Second color filter 132 may display light in a second color 142 and filter received light 138 in accordance with displayed second color 142. Third color filter 134 may display light in a third color 144 and filter received light 138 in accordance with displayed third color 144. Fourth color filter 136 may display light in a fourth color 146 and filter received light 138 in accordance with displayed fourth color 146.

In an example where display 104 comprises RGB subpixels and icon 118 comprises an RGBY color filter, display 104 may be controlled (e.g. by logo camera controller 110) to display icon 118 as, for example, (i) an active block (e.g. array or group) of green subpixels aligned with first lens 166 and first sensor or sensor region 174, (ii) an active block of red subpixels aligned with second lens 168 and second sensor or sensor region 176, (iii) an active block of blue subpixels aligned with third lens 170 and third sensor or sensor region 178, and (iv) an active block of red and green subpixels (e.g. to filter yellow light) aligned with fourth lens 172 and fourth sensor or sensor region 180. Red, green, blue and yellow blocks of color may comprise any shade or intensity, which may be accounted for during processing of received color-separated images by image processor 116. In an example, color filter portions of icon 118 providing color filtering may be separated from other colors, e.g., by a mask of subpixels. In an example, each of the four color filters may comprise a 10×10 array of pixels separated by four pixels (e.g. as shown by example in FIG. 6). In an example, a passive or active icon/color filter may be, for example, single digits to tens of millimeters in size (e.g. tens to low hundreds of pixels across).

In an example of image processing (e.g. by image processor 116), four sets of data may be obtained from four quadrants or regions of sensor(s) 128. The four sets of data may be labeled, respectively, r, g, b and y. Registration may be performed on the data, for example, to align pixels in the four representations of color-separated images. Deconvolution and denoising may be performed (e.g. by known methods) and/or by neural network methods.

In an example where icon-logo colors are pure red {255, 0, 0}, pure green {0, 255, 0}, pure blue {0, 0, 255} and pure yellow {255, 255, 0} and where display RGB subpixel filters are a close match to sRGB filter primaries, a resulting (e.g. combined) RGB image may be calculated (e.g. approximately) from r, g, b and y, for example, in accordance with Equation 1:

$$( \begin{matrix}R \\ G \\ B\end{matrix} ) = ( \begin{matrix}2 / 3 & - 1 / 3 & 0 & 1 / 3 \\ - 1 / 3 & 2 / 3 & 0 & 1 / 3 \\ 0 & 0 & 1 & 0\end{matrix} ) \cdot ( \begin{matrix}r \\ g \\ b \\ y\end{matrix} ) \qquad Equation 1$$

Equation 1 (and other conversion equations for other color models) may be adapted to different shades. In an example where icon-logo colors are RGB subpixel color shades: red {246, 83, 20}, green {124, 187, 0}, blue {0, 161, 241}, and yellow {255, 187, 0}, a resulting (e.g. combined) RGB image may be calculated (e.g. approximately) from r, g, b and y, for example, in accordance with Equation 2:

$$( \begin{matrix}R \\ G \\ B\end{matrix} ) = ( \begin{matrix}1.11 B & - 0.657 & - 0.093 & 0.241 \\ - 1.079 & 1.411 & 0.09 & 0.354 \\ 0.739 & - 0.921 & 0.997 & - 0.266\end{matrix} ) \cdot ( \begin{matrix}r \\ g \\ b \\ y\end{matrix} ) \qquad Equation 2$$

Color conversion may be more prone to noise, for example, when colors (e.g. r, g, b and y) are less saturated in an icon-logo. Light loss and diffraction artifacts (e.g. due to passing light through a display) may be computationally removed (e.g. following combination of color-separated images into an RGB image representation). In an example, a neural network may be used to learn the difference between obscured and unobscured light or images and the learned difference may be computationally applied to correct for light loss and diffraction.

Light guide 120 may guide (e.g. direct) displayed light (e.g. light from a light source such as an LED array) and received light. Light guide 120 comprise a plate, panel or film configured to guide light from a light source in display 104 and to guide light received through optical paths to sensor(s) 128. Light guide 120 may comprise, for example, polymethyl methacrylate (PMMA) or any other transparent polymer (e.g. polycarbonate, cyclic olefin polymer (COP) or polystyrene). Light guide 120 may be etched with a light-directing pattern. Light guide 120 may be implemented in a front-facing logo camera and in an illuminated or an active rear-facing logo camera. In an example of a front-facing logo camera, light guide 120 may be part of a display, positioned, for example, at the rear of layers in display 104 (e.g. in front of reflector 122). In an example of a rear-facing logo camera, light guide 120 may comprise part of a rear-facing display or may comprise part of illumination provided to icon 118.

Reflector 122 may comprise a reflector in display 104. Reflector 122 may be positioned, for example, at the rear of layers in display 104. Reflector 122 may be provided with multiple holes (e.g. openings, apertures) to support multiple optical paths between icon/color filter 118 and sensor(s) 128. Reflector 122 may include (i) first hole 148 in a first optical path between first color filter 130 through first lens 166 to first sensor or sensor region 174, (ii) second hole 150 in a second optical path between second color filter 132 through second lens 168 to second sensor or sensor region 176, (iii) third hole 152 in a third optical path between third color filter 134 through third lens 170 to third sensor or sensor region 178, and (iv) fourth hole 154 in a fourth optical path between fourth color filter 136 through fourth lens 172 to fourth sensor or sensor region 180. In an example, reflector 122 may comprise a white or silver sheet or film.

Shutter 124 may comprise one or more shutters and/or independently operable regions. Shutter 124 may be positioned, for example, between reflector 122 and lens array 126. Shutter 124 may comprise a single shutter or an array of shutters, e.g., first shutter 158, second shutter 160, third shutter 162, fourth shutter 164 and so on. Multiple shutters (e.g. first through fourth shutters 158, 160, 162, 164) may be discrete or may be separately controlled regions of a shutter. In an example, shutter 124 or its elements (e.g. first through fourth shutters 158, 160, 162, 164) may comprise, for example, polymer-disperse liquid crystal that masks camera apertures in backlight control films (e.g. reflector 122). Shutter 124 or its elements (e.g. first through fourth shutters 158, 160, 162, 164) may be controlled by logo camera controller 110. In an example of independent control of first through fourth shutters 158, 160, 162, 164, a user may select a tri-color model (e.g. RGB) over a quad-color model (e.g. RGBY) utilizing three cameras instead of four available cameras. Logo camera controller 110 may close fourth shutter 164 while the user-selected color model and associated icon(s) remain in effect, whereas first, second and third shutters 158, 160 and 162 may be opened and closed relative to logo camera usage.

Lens array 126 may comprise an array of lenses. Lens array 126 may be positioned between shutter 124 and sensor(s) 128. Lens array 126 may focus color-separated light onto sensor(s) 128. Lens array 126 may comprise, for example, multiple discrete lenses, each with a stack of optical elements, or an integrated array of lenses formed by a stack of layers (e.g. sheets) with multiple optical elements (e.g. as shown by example in FIG. 4). Lens array 126 may comprise, for example, first lens 166, second lens 168, third lens 170 and fourth lens 172. First lens 166 may focus first color-separated light from first color filter 130 onto first sensor or sensor region 174. Second lens 168 may focus second color-separated light from second color filter 132 onto second sensor or sensor region 176. Third lens 170 may focus third color-separated light from third color filter 134 onto third sensor or sensor region 178. Fourth lens 172 may focus fourth color-separated light from fourth color filter 136 onto fourth sensor or sensor region 180.

Sensor(s) 128 may comprise one or more image sensors. Sensor(s) 128 may comprise, for example, CMOS image sensors. Sensor(s) 128 may be implemented without a color filter, for example, given external color filter 118 providing color-separated light to sensor(s) 128. Sensor(s) 128 may be implemented with a microlens array. In an example, sensor(s) 128 may comprise a single sensor that receives multiple color-separated images in different areas or regions, such as first sensor region 174, second sensor region 176, third sensor region 178 and fourth sensor region 180. In another example, sensor(s) 128 may comprise multiple (e.g. discrete) image sensors, such as first sensor 174, second sensor 176, third sensor 178 and fourth sensor 180. First sensor or sensor region 174 may receive first color-separated light from first color filter 130. Second sensor or sensor region 176 may receive second color-separated light from second color filter 132. Third sensor or sensor region 178 may receive fourth color-separated light from fourth color filter 134. Fourth sensor or sensor region 180 may receive first color-separated light from fourth color filter 137. In an example, discrete sensors or sensor regions (e.g. first through fourth sensors or sensor regions 174, 176, 178, 180) may be configured (e.g. selected, enhanced or optimized), for example, to (e.g. ranges of) wavelengths (e.g. colors) of light they may be configured to receive. Wavelength range-specific sensor(s) may increase light efficiency, for example. Sensor(s) 128 may provide sensed image signals to computing device 102, for example, for processing by image processor 116.

FIGS. 2A-2B provide examples of front-facing and rear-facing logo cameras in a portable computing device, according to an example embodiment. FIG. 2A shows a front (e.g. main display) side 200A of portable computing device 202. FIG. 2B shows a rear side 200A of portable computing device 202. Portable computing device 202 may comprise any mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device. In an example, portable computing device 202 may comprise display 208 on its front side 200A and rear case 210 on its rear side 200B.

Front-facing logo camera icon/color filter 204 may be visible, for example, when the front-facing logo camera is on. Front-facing logo camera icon 204 may comprise an active color filter for a front-facing logo camera. Icon 204 may (e.g. in addition to displaying colored light) filter light received by display 208 into color-separated light for sensor(s) 128. Front-facing logo camera icon/color filter 204 may be activated and deactivated, for example, by controlling subpixels in a region of display 208 in an optical path with logo camera elements (e.g. lens array 126 and sensor(s) 128). Illumination of a display (e.g. and actively displayed icon/color filter 206) may be synchronized with a (e.g. software) camera shutter. Camera shuttering may be synchronized with a display refresh rate. In an example, display illumination and camera shuttering may be alternated in frames in a timed cycle at a frequency undetectable by a human observer. For example, in a first frame, a camera shutter may be open to permit sensor(s) 128 to detect color-separated images while display illumination is OFF, in a second frame the camera shutter may be closed while icon illumination is ON, and so on. Thus, while a human observer may see icon/color filter 204 as being ON constantly while a logo camera is in use, icon/color filter 204 may be cycled ON and OFF to permit sensor(s) to detect color-separated images of received light.

Front-facing logo camera icon/color filter 204 may provide an in-use notification (e.g. when logo camera is ON). Front-facing logo camera icon/color filter 204 may or may not (e.g. also) convey information, such as by representing a company logo for a company that manufactured or owns portable computing device 202, or a personal avatar representing a user of portable computing device 202. In an example, icon 204 may comprise multicolored initials or a symbol for a user or an acronym or symbol for a company. Front-facing logo camera icon/color filter 204 may (e.g. alternatively) be decorative (e.g. a scenic icon such as red Sun, blue sky and green grass).

Portions of icon 204 may be unrelated to color filtering. The size of icon 204 may be larger than necessary to provide color filtering for a front-facing logo camera, for example, to conceal color filters, present an icon more clearly, etc. Front-facing logo camera icon/color filter 204 may be fixed or variable. In an example, an icon may be variable based on user selection. A user may select (e.g. configure and reconfigure) icon 204, icon colors, icon size, etc.

Rear-facing logo camera icon/color filter 206 may be visible (or more readily visible), for example, when the rear-facing logo camera is on. Rear-facing logo camera icon 206 may comprise a fixed or variable, passive and/or active color filters for a rear-facing logo camera.

In an example, rear-facing logo camera icon/color filter 206 may comprise passive (e.g. fixed) color filters. For example, rear-facing logo camera icon/color filter 206 may comprise a translucent material, such as, for example, color dyed acrylic or glass visible to a user in optical paths with logo camera elements (e.g. lens array 126 and sensor(s) 128). Icon/color filter 206 may be made more prominent, for example, by placing a semi-reflective layer behind icon/color filter 206. In an example implementation, a semi-reflective layer (e.g. reflector 122) may be applied between icon/color filter 206 and lens array 126, for example, to mask the rear facing logo camera and improve visibility of colors in icon 206. One or more light sources (e.g. LEDs) may illuminate rear-facing logo camera icon/color filter 206, for example, when the rear-facing camera is ON. In an example implementation, a weakly scattering light guide plate (e.g. light guide plate 120) may be lit by one or more lights (e.g. LEDs) to illuminate icon/color filter 206. Illumination of passively displayed icon/color filter 206 may be synchronized with a (e.g. software) camera shutter. In an example, display illumination and camera shuttering may be alternated in frames in a timed cycle at a frequency undetectable by a human observer. For example, in a first frame, a camera shutter may be open to permit sensor(s) 128 to detect color-separated images while icon illumination is OFF, in a second frame the camera shutter may be closed while icon illumination is ON, and so on. Thus, while a human observer may see icon/color filter 204 as being ON constantly while a logo camera is in use, icon/color filter 204 may be cycled ON and OFF to permit sensor(s) to detect color-separated images of received light.

Rear-facing logo camera icon/color filter 206 may provide an in-use notification (e.g. when logo camera is ON). Rear-facing logo camera icon/color filter 206 may or may not (e.g. also) convey information, such as by representing a company logo for a company that manufactured or owns portable computing device 202, or a personal avatar representing a user of portable computing device 202. In an example, rear-facing logo camera icon/color filter 206 may comprise multicolored initials or a symbol for a user or an acronym or symbol for a company. Rear-facing logo camera icon/color filter 206 may (e.g. alternatively) be decorative (e.g. a scenic icon such as red Sun, blue sky and green grass).

Portions of rear-facing logo camera icon/color filter 206 may be unrelated to color filtering. The size of rear-facing logo camera icon/color filter 206 may be larger than necessary to provide color filtering for a front-facing logo camera, for example, to conceal color filters, present an icon more clearly, etc.

In another example, rear-facing logo camera icon/color filter 206 may comprise an active icon/color filter (e.g. using an LCD). In an example, an (e.g. active) icon may be variable based on user selection. A user may select (e.g. configure and reconfigure) rear-facing logo camera icon/color filter 206, icon colors, icon size, etc. An active rear-facing logo camera icon/color filter 206 may (e.g. in addition to displaying colored light) filter light received by display 204 into color-separated light for sensor(s) 128.

FIG. 3 is a block diagram of an example logo camera in a display screen of a computing device, according to an example embodiment. Example system 300 may comprise, for example, a desktop computer 302 and one or more input devices (e.g. keyboard) 306. Display 304 may comprise any type of display (e.g. a computer monitor, a television and so on). Indeed, computer system 300 itself may comprise a television with an integrated logo camera.

Logo camera icon/color filter 308 in display 304 may be visible, for example, when a logo camera is on. Logo camera icon 308 may comprise an active color filter for a logo camera. Icon 308 may (e.g. in addition to displaying colored light) filter light received by display 304 into color-separated light (e.g. for sensor(s) 128). Logo camera icon/color filter 308 may be activated and deactivated, for example, by controlling subpixels in a region of display 304 in an optical path with logo camera elements (e.g. lens array 126 and sensor(s) 128).

Logo camera icon/color filter 308 may provide an in-use notification (e.g. when logo camera is ON). Logo camera icon/color filter 308 may or may not (e.g. also) convey information, such as by representing a company logo for a company that manufactured or owns system 300, or a personal avatar representing a user of system 300. In an example, icon 308 may comprise multicolored initials or a symbol for a user or an acronym or symbol for a company. Logo camera icon/color filter 308 may (e.g. alternatively) be decorative (e.g. a scenic icon such as red Sun, blue sky and green grass).

Portions of icon 308 may be unrelated to color filtering. The size of icon 308 may be larger than necessary to provide color filtering for a front-facing logo camera, for example, to conceal color filters, present an icon more clearly, etc. Icon/color filter 308 may be fixed or variable. In an example, an icon may be variable based on user selection. A user may select (e.g. configure and reconfigure) icon 308, icon colors, icon size, etc.

FIG. 4 is a block diagram of an example lens array for a logo camera, according to an example embodiment. Example lens array 400 may be manufactured as an array of lenses, e.g. as opposed to individual or discrete lenses. Lens array 400 may be assembled from multiple (e.g. six) lens elements. In an example, lens array 400 may comprise an array of f/1.8 lenses.

FIG. 5 is a block diagram of an example of a camera color filter providing a camera-use indication, an icon and color filtering for a logo camera, according to an example embodiment. Example icon 500 may comprise a fixed or variable, actively or passively presented icon and color filter. Example icon 500 may concurrently notify a user that logo camera is on, provide a color filter for the logo camera, and present a logo, avatar or other image.

Colors of first through fourth color filters 504, 506, 508, 510 may be based on any color model (e.g. RGBY, RGBW, RGGB, RGBE, RYYB, CMYW, CYYM, CYGM, and so on). In an example, first through fourth color filters 504, 506, 508, 510 may have RGBY colors.

In an example of passively displaying icon 500, icon 500 may comprise a translucent material, such as, for example, color dyed acrylic (e.g. PMMA) or glass visible to a user in optical paths with logo camera elements (e.g. lens array 126 and sensor(s) 128). Example passively displayed icon 500 may comprise, for example, a first (e.g. red) dyed area creating first color filter 504, a second (e.g. green) dyed area creating second color filter 506, a third (e.g. blue) dyed area creating third color filter 508, and a fourth (e.g. yellow) dyed area creating fourth color filter 510, separated, for example, by an opaque mask. Passively displayed icon 500 may be more prominent, for example, by placing a semi-reflective layer (e.g. reflector 122) behind icon 500. Passively displayed icon 500 may (e.g. alternatively) be illuminated (e.g. by one or more LEDs with a light guide), for example, when a logo camera is ON.

In an example of actively displaying icon 500, icon 500 may comprise (e.g. as shown by example in FIG. 6), multiple groups of active color-separated pixels on a computing device display visible to a user in optical paths with logo camera elements (e.g. lens array 126 and sensor(s) 128). Example actively displayed icon 500 may comprise, for example, a first group of active (e.g. red) pixels creating first color filter 504, a second group of active (e.g. green) pixels creating second color filter 506, a third group of active (e.g. blue) pixels creating third color filter 508, and a fourth group of active (e.g. yellow) pixels creating fourth color filter 510, separated, for example, by a mask of inactive (OFF) pixels.

FIG. 6 is a block diagram of an example of active display pixels providing a camera-use indication, an icon and color filtering for a logo camera, according to an example embodiment. Example display 600 may comprise any type and size of display. In an example, display 104 may comprise an LCD, an LED display, an OLED display, an AMOLED display, a QDLED display, an EL display, a PLP, etc. Example display 600 may comprise a main (e.g. front-facing) display or other display (e.g. a secondary rear display). Example display 600 may comprise pixel array 602.

Pixel array 602 may comprise an array of pixels (e.g. pixels 604, 606, 608, 610, 612, 614, 616, 618, 620). Each pixel 604, 606, 608, 610, 612, 614, 616, 618, 620 may comprise a color filter array of subpixels, such as a red (R) subpixel, a green (G) subpixel and a blue (B) subpixel. Other color model subpixel arrays may be implemented. Each subpixel may have a range of shades (e.g. 256 shades) and intensities (e.g. 1024 levels), which may be combined with shades and intensities of other subpixels to permit each pixel to display and filter millions of colors of light. In an example, light color displayed (and filtered) and light intensity displayed by each pixel may be controlled by controlling how much light passes through liquid crystal to each subpixel of the color filter array of RGB subpixels.

Example display 600 may support one or more logo cameras facing any direction (e.g. front-facing, rear-facing, side-facing). A logo camera may comprise an array of cameras or camera elements (e.g. lens and sensor). Some or all logo camera elements may be positioned behind a display (e.g. display 602). Logo camera elements may include display elements, for example, when logo camera lenses and sensors receive light through display elements.

Pixel array 602 may be controlled (e.g. by logo camera controller 110) to display active color filters optically aligned with multiple cameras or multiple camera elements (e.g. lenses and sensors) for a logo camera. A (e.g. separate) color filter may be provided for each (e.g. separate) camera or camera element. Each color filter may be different from other color filters (e.g. red, green, blue) or may have some repetitive colors (e.g. red, green, green, blue). An array of active color filters need not, but may, serve multiple (e.g. additional) purposes, such as (e.g. concurrently) providing a logo camera in-use or “ON” notification, displaying a company logo, a personal avatar, or another image or images. An array of color filters may be a standalone icon or may be concealed in an icon with more active pixels than needed to provide active color filters for a logo camera.

Example display 600 may present an icon comprising active color filter array 630. Color filter array 630 may comprise a 2×2 color filter array. Color filter array 630 may comprise first color filter 622, second color filter 624, third color filter 626 and fourth color filter 628. First through fourth active color filters 622, 624, 626, 628 may comprise components in a multi-element camera (e.g. multi-camera or camera array). First through fourth color filters 622, 624, 626, 628 may be displayed at positions on display 600 in alignment with cameras or camera elements (e.g. first through fourth lenses 166, 168, 170, 172 and first through fourth sensors or sensor regions 174, 176, 178, 180) in order for sensor(s) to receive color-separated light through first through fourth color filters 622, 624, 626, 628.

Colors of first through fourth color filters 622, 624, 626, 628 may be based on any color model (e.g. RGBY, RGBW, RGGB, RGBE, RYYB, CMYW, CYYM, CYGM, and so on). In an example, first through fourth color filters 622, 624, 626, 628 may have RGBY colors. In an example, each of first through fourth active color filters 622, 624, 626, 628 may comprise a 10×10 array of pixels separated by four pixels. For example, first color filter 622 may comprise a 10×10 pixel block (e.g. array or group) of active green subpixels aligned with first lens 166 and first sensor or sensor region 174. Second color filter 624 may comprise a 10×10 pixel block of active red subpixels aligned with second lens 168 and second sensor or sensor region 176. Third color filter 626 may comprise a 10×10 pixel block of active blue subpixels aligned with third lens 170 and third sensor or sensor region 178. Fourth color filter 628 may comprise a 10×10 block of active red and green subpixels (e.g. to display and filter yellow light) aligned with fourth lens 172 and fourth sensor or sensor region 180.

Red, green, blue and yellow blocks of color may comprise any shade or intensity, which may be accounted for during processing of received color-separated images by image processor 116. In an example, first through fourth color filters 622, 624, 626, 628 may have RGBY colors with the following {RGB} subpixel color shades: red {246, 83, 20}, green {124, 187, 0}, blue {0, 161, 241}, and yellow {255, 187, 0}. As indicated by RGB subpixel shades, multiple subpixels may be active for each color filter.

FIGS. 7A-C show additional examples of icons (e.g. logos, avatars, flags and so on), color filter configurations, and color model configurations, according to example embodiments. Icons and color filter examples shown in FIGS. 7A-C may comprise fixed or variable, active or passive icons and color filters.

FIG. 7A shows an example of a 1×4 linear color filter array concealed in an icon or logo. Example icon 700A comprises multiple colored icon elements. In an example, icon 700A comprises four parallel vertical rectangles, e.g., green rectangle 704, red rectangle 708, white rectangle 712 and blue rectangle 716. These rectangular colored icon elements may comprise a company logo, a personal avatar or any other image. The rectangular shaped colors may be positioned to be in optical alignment with and to provide color filtered light to an array of cameras or camera elements for a logo camera. For example, green rectangle 704 may serve as a green color filter 702 to provide green color-separated light to a first camera or camera element. Red rectangle 708 may serve as a red color filter 706 to provide red color-separated light to a second camera or camera element. White rectangle 712 may serve as a clear color filter 710 to provide white color-separated light to a third camera or camera element. Blue rectangle 716 may serve as a blue color filter 714 to provide blue color-separated light to a fourth camera or camera element.

FIG. 7B shows an example of an 1×4 asymmetrical color filter array concealed in an icon or logo. Example icon 700B comprises multiple colored icon elements. In an example, icon 700B comprises four triangles arranged to form a larger triangle, e.g., cyan triangle 720, magenta triangle 726, yellow triangle 728 and white triangle 730. These triangular colored icon elements may comprise a company logo, a personal avatar or any other image. The triangular shaped colors may be positioned to be in optical alignment with and to provide color filtered light to an array of cameras or camera elements for a logo camera. For example, cyan triangle 720 may serve as a cyan color filter 722 to provide cyan color-separated light to a first camera or camera element. Magenta triangle 726 may serve as a magenta color filter 724 to provide magenta color-separated light to a second camera or camera element. Yellow triangle 728 may serve as a yellow color filter 732 to provide yellow color-separated light to a third camera or camera element. White triangle 730 may serve as a clear color filter 734 to provide white color-separated light to a fourth camera or camera element. Implementations with a wide variety of color models and shades may use all or fewer than all available filters and cameras for various logo implementations.

FIG. 7C shows an example of a 1×3 linear color filter array concealed in an icon or logo. Example icon 700C comprises multiple colored icon elements. In an example, icon 700C comprises three colored areas separated by thick curved gray boundaries, e.g., red area 740, green area 742 and blue area 746. These colored icon elements may comprise a company logo, a personal avatar or any other image. The shaped colored areas may be positioned to be in optical alignment with and to provide color filtered light to an array of cameras or camera elements for a logo camera. For example, red area 740 may serve as a red color filter 748 to provide red color-separated light to a first camera or camera element. Green area 742 may serve as a green color filter 750 to provide green color-separated light to a second camera or camera element. Blue area 746 may serve as a blue color filter 752 to provide blue color-separated light to a third camera or camera element.

Implementations are not limited to the examples shown. Example icons and color filters presented in FIGS. 5, 6, 7A, 7B and 7C represent only a few of an unlimited number of implementations of logo camera icons and color filter combinations.

Embodiments may also be implemented in processes or methods. Examples shown and discussed with respect to FIGS. 1-7A-C may operate, for example, according to example methods presented in FIG. 8.

FIG. 8 shows a flowchart of a method for providing a logo camera, according to an example embodiment. Embodiments disclosed herein and other embodiments may operate in accordance with example method 800. Method 800 comprises steps 802-820. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 8. FIG. 8 is simply one of many possible embodiments. Embodiments may implement fewer, more or different steps.

Method 800 comprises step 802. In step 802, a camera icon selection may be received. For example, as shown in FIGS. 1, 3 and 9, computing device 102, 300 or 900 may receive a logo camera icon selection from a user input device, e.g., based on user interaction with logo camera controller 110 icon menu 112.

In step 804, an indication may be received to turn on (front- and/or rear-facing) camera(s). For example, as shown in FIGS. 1, 3 and 9, computing device 102, 300 or 900 may receive an indication to activate a front and/or rear logo camera, e.g., based on user interaction with an input device for computing device 102, 300 or 900, such as user selection of a logo camera in a touch screen menu.

In step 806, camera use notification, icon-logo and color filter may be provided using camera color filter. For example, as shown in FIGS. 1, 2, 3, 5, 6 and 7A-C, passive and/or active logo camera icon/color filter may be activated, e.g., by activating display pixels for an active icon/color filter or by illuminating a passive icon/color filter.

In step 808, a camera shutter may be opened. For example, as shown in FIG. 1, shutter 124 (as a whole) or first, second, third and/or fourth shutters 158, 160, 162, 164 may be opened when logo camera is ON to provide an optical path to sensor(s) 128.

In step 810, received light may be filtered by the color filter into color-separated light. For example, as shown in FIGS. 1, 5, 6 and 7A-C, received light may be filtered by color filters (e.g. 130, 132, 134, 136 or 504, 506, 508, 510 or 622, 624, 626, 628 or 702, 706, 710, 714 or 722, 724, 732, 734 or 748, 750, 752).

In step 812, each color of the color separated light may be focused onto at least one image sensor. For example, as shown in FIG. 1, first through fourth lenses 166, 168, 170, 172 may focus color-separated light from first through fourth color filters 130, 132, 134, 136 onto first through fourth sensors or sensor regions 174, 176, 178, 180.

In step 814, a representation of a color-separated image may be generated for each received color of color-separated light. For example, as shown in FIG. 1, first through fourth sensors or sensor regions 174, 176, 1778, 180 may generate signals representing color-separated images they received.

In step 816, the plurality of representations of color-separated images may be combined into a representation of a combined image. For example, as shown in FIG. 1, image processor 116 may process image signals provided by first through fourth sensors or sensor regions 174, 176, 178, 180 into a combined representation of a combined image.

In step 818, an indication may be received to turn off (front- and/or rear-facing) camera(s). For example, as shown in FIGS. 1, 3 and 9, computing device 102, 300 or 900 may receive an indication to deactivate a front and/or rear logo camera, e.g., based on user interaction with an input device for computing device 102, 300 or 900, such as user selection of an icon to close a logo camera in a touch screen menu.

In step 820, the camera may be concealed with a shutter or a semi-reflective layer. For example, as shown in FIG. 1, shutter 124 (as a whole) or first, second, third and/or fourth shutters 158, 160, 162, 164 may be closed when logo camera is OFF to block an optical path to sensor(s) 128.

### III. Example Computing Device Embodiments

As noted herein, the embodiments described, along with any modules, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

FIG. 9 shows an exemplary implementation of a computing device 900 in which example embodiments may be implemented. Consistent with all other descriptions provided herein, the description of computing device 900 is a non-limiting example for purposes of illustration. Example embodiments may be implemented in other types of computer systems, as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random-access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing example embodiments described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium” are used to refer to physical hardware media such as the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media that are separate and non-overlapping with embodiments directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of example embodiments described herein. Accordingly, such computer programs represent controllers of the computing device 900.

Example embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

Methods, systems and computer program products are provided for a logo camera. Camera thickness may be reduced using multiple lenses and sensors (e.g. to reduce focal length). A fixed or variable color icon (e.g. for front and/or rear-facing cameras) may (e.g. simultaneously) provide a function (e.g. fixed or variable camera filter), provide a notice or privacy warning (e.g. camera in-use notification), convey information (e.g. product manufacturer and/or ownership logo(s), personal or unique avatar), and/or serve decorative and/or other purposes. Color filters may be fixed or variable. A color icon may be created, for example, by controlling the colors of display pixels aligned with optical paths of camera lens and sensor arrays. Colors in an icon may provide color filters (e.g. according to any of various color models) corresponding to an array of lenses that focus color-separated light on one or more camera sensors. Sensors may be configured for particular colors. Color-separated images may be combined into a single image. Lens and camera sensor arrays may be compatible with multiple (e.g. selectable) logos or other icon images. Cameras behind fixed or variable color icons may be concealed (e.g. when not in use), for example, using (e.g. liquid crystal) shutters or semi-reflective layers.

In an example, a camera may comprise, for example, a color filter array comprising a plurality of color filters configured to filter received light into a plurality of colors of color-separated light; a lens array comprising a plurality of lenses configured to focus each color of the color-separated light onto at least one image sensor; and the at least one image sensor configured to generate a plurality of representations of color-separated images comprising a representation of a color-separated image for each received color of the color-separated light; and wherein the color filter array provides notification that the camera is on.

In an example, the camera may further comprise, for example, a light source configured to illuminate the color filter array to display a color-separated icon when the camera is in use.

In an example, the plurality of color filters may comprise, for example, color-separated groups of active display color filter pixels configured to, when the camera is on, (i) display an icon comprising groups of color-separated pixels and (ii) filter the received light into the plurality of color-separated images.

In an example, colors of the color filter array may comprise colors in a color model.

In an example, colors of the color filter array may be selected and arranged to form a company logo.

In an example, the at least one image sensor may comprise an array of image sensors. A (e.g. each) sensor in the array of image sensors may be configured (e.g. selected, enhanced or optimized) for a color of a color filter in the plurality of color filters.

In an example, at least one image processor may be configured to combine the plurality of representations of the color-separated images into a combined image.

In an example, the camera may further comprise at least one of the following: (i) a shutter configured to mask or conceal the camera when the camera is off; and (ii) a semi-reflective layer behind the color filter array.

In an example, the shutter may comprise a liquid crystal shutter.

In an example, the at least one image sensor may not comprise a color filter.

In an example, a method may comprise, for example, providing a notification, by a color filter for a camera, that the camera is on; filtering, by the color filter when the camera is on, received light into a plurality of colors of color-separated light; and focusing each color of the color-separated light onto at least one image sensor.

In an example, the color filter may be illuminated when the camera is in use.

In an example, the color filter may comprise color-separated groups of active color filter pixels for a display that (i) display an icon comprising groups of color-separated pixels and (ii) filter the received light into the plurality of color-separated images.

In an example, colors of the color filter may be selected and arranged to form a company logo.

In an example, generating a plurality of color-separated images may comprise a color-separated image for each received color of the color-separated light.

In an example, the method may further comprise, for example, combining the plurality of color-separated images into a combined image.

In an example, the method may further comprise, for example, concealing the camera when the camera is off with a shutter or a semi-reflective layer behind the color filter.

In an example, a computing device may comprise, for example, a display with a display color filter; an image sensor positioned behind and configured to receive light through a portion of the display including a portion of the display color filter; and a controller configured to provide a visual indication that the image sensor is on and create a color filter for the image sensor by activating a plurality of pixels in the portion of the display color filter to form a plurality of color-separated pixel groups.

In an example, the controller may be further configured to permit a user to select at least one of (i) an icon from a plurality of icons to display as the visual indication, and (ii) a color model for the color filter.

In an example, the computing device may further comprise, for example, at least one sensor configured to receive a plurality of color separated images through the color filter comprising a plurality of color-separated pixel groups.

In an example, a display may comprise an active or passive color filter array visible to a person to provide a plurality of color-separated images passing through the passive or active color filter array to at least one image sensor positioned behind the display, where the active or passive color filter array may itself comprise an icon (e.g. a logo or avatar) or may be integrated in or concealed by an icon and where the color filter and/or icon may be illuminated (e.g. by active pixels or other illumination source) to provide notification to the person that the at least one image sensor is on.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

1. A camera, comprising:
a color filter array comprising a plurality of color filters configured to filter received light into a plurality of colors of color-separated light, wherein each color filter in the plurality of color filters comprises a group of contiguous pixels each of which is configured to filter the received light into a corresponding color in the plurality of colors of the color-separated light;
a lens array comprising a plurality of lenses configured to focus each color of the color-separated light onto at least one image sensor, wherein each lens in the plurality of lenses is aligned with a corresponding color filter in the plurality of color filters; and
the at least one image sensor configured to generate a plurality of representations of color-separated images comprising a representation of a color-separated image for each received color of the color-separated light; and
wherein the color filter array is configured to provide notification that the camera is on.

2. The camera of claim 1, further comprising:
a light source configured to illuminate the color filter array to display a color-separated icon when the camera is in use.

3. The camera of claim 1, wherein the plurality of color filters comprise color-separated groups of active display color filter pixels configured to, when the camera is on, (i) display an icon comprising groups of color-separated pixels and (ii) filter the received light into the plurality of color-separated images.

4. The camera of claim 2, wherein colors of the color filter array comprise colors in a color model.

5. The camera of claim 2, wherein colors of the color filter array are selected and arranged to form a company logo.

6. The camera of claim 1, wherein the at least one image sensor comprises an array of image sensors; and wherein each sensor in the array of image sensors is configured for a color range of a color filter in the plurality of color filters.

7. The camera of claim 1, further comprising:
at least one image processor configured to combine the plurality of representations of the color-separated images into a combined image.

8. The camera of claim 1, further comprising at least one of the following:
a shutter configured to mask or conceal the camera when the camera is off; and
a semi-reflective layer behind the color filter array.

9. The camera of claim 8, wherein the shutter comprises a liquid crystal shutter.

10. The camera of claim 1, wherein the at least one image sensor does not comprise a color filter.

11. A method, comprising:
providing a notification, by a color filter for a camera, that the camera is on;
filtering, by the color filter when the camera is on, received light into a plurality of colors of color-separated light, wherein the color filter comprises a plurality of groups of contiguous pixels each of which is configured to filter the received light into a corresponding color in the plurality of colors of the color-separated light; and
focusing each color of the color-separated light onto at least one image sensor by a respective lens of a plurality of lenses, wherein each respective lens of the plurality of lenses aligns with a corresponding group of contiguous pixels of the plurality of groups of contiguous pixels.

12. The method of claim 11, wherein the color filter is illuminated when the camera is in use.

13. The method of claim 11, wherein the color filter comprises color-separated groups of active color filter pixels for a display that (i) display an icon comprising groups of color-separated pixels and (ii) filter the received light into the plurality of color-separated images.

14. The method of claim 12, wherein colors of the color filter are selected and arranged to form a company logo.

15. The method of claim 11, wherein each color is received by a separate region of one sensor or by a separate sensor, further comprising:
generating a plurality of color-separated images comprising a color-separated image for each received color of the color-separated light.

16. The method of claim 15, further comprising:
combining the plurality of color-separated images into a combined image.

17. The method of claim 11, further comprising:
concealing the camera when the camera is off with a shutter or a semi-reflective layer behind the color filter.

18. A computing device comprising:
a display with a display color filter;
a lens array comprising a plurality of lenses configured behind the display color filter;
an image sensor positioned behind and configured to receive light through a portion of the display including a portion of the display color filter; and
a controller configured to provide a visual indication that the image sensor is on and create a color filter for the image sensor by activating a plurality of pixels in the portion of the display color filter to form a plurality of color-separated pixel groups of contiguous pixels, wherein each of the color-separated pixel groups of contiguous pixels is aligned with a respective lens of the lens array and each respective lens is configured to focus the light received by the image sensor through the portion of the display color filter onto the image sensor.

19. The computing device of claim 18, wherein the controller is further configured to permit a user to select at least one of (i) an icon from a plurality of icons to display as the visual indication, and (ii) a color model for the color filter.

20. The computing device of claim 18, further comprising:
at least one sensor configured to receive a plurality of color separated images through the color filter comprising a plurality of color-separated pixel groups.
